(19) United States
(12) Patent Application Publication
(10) Pub. No.: US 2004/0185744 A1
(43) Pub. Date: Sep. 23, 2004

(54) Method of manufacturing color-separating electrode structure for color cathode ray tube

(76) Inventors: Masahiro Nakazawa, Tokyo (JP); Takeshi Tsukasaki, Tokyo (JP); Shinichi Ooe, Tokyo (JP); Yoshio Mizumoto, Tokyo (JP)

Correspondence Address: BIRCH STEWART KOLASCH & BIRCH, PO BOX 747, FALLS CHURCH, VA, 22040-0747, US

(21) Appl. No.: 10/739,125

(22) Filed: Dec. 19, 2003

(30) Foreign Application Priority Data
Mar. 19, 2003 (JP) 2003-074759

(51) Int. Cl. H01J 9/12; H01J 9/236

(52) U.S. Cl. 445/47; 445/36; 445/37

(57) ABSTRACT

In a method of manufacturing a color-separating electrode structure for color cathode ray tube, welding is performed by rolling a roller electrode with a rotation shaft being tilted so that an electrode surface of the roller electrode faces to an inside of a substantially rectangular frame, and by pressing a pressing roller to a portion defined as the portion of an outside of a contact portion in which an outer edge portion of an upper surface of the side of the frame is kept in contact with a rear surface of the color-separating electrode, both the roller electrodes and the pressing rollers being rolled together along the contact portion, whereby the color-separating electrode structure having sufficient welding strength can be obtained with higher stability.

### BACKGROUND OF THE INVENTION

1. Field of the Invention

The present invention relates to a method of manufacturing a color-separating electrode structure for use in a color CRT (Cathode Ray Tube).

2. Description of Related Art

It is known in the prior art that a method of manufacturing a color-separating electrode structure for use in a color CRT is achieved by applying a compression force to a substantially rectangular frame in a direction that decreases a distance between at least one pair of opposite sides of the frame, and applying a tension force to a color separating electrode (generally referred to as a shadow mask or an aperture grill) made of a thin metal plate having a number of electron beam passing holes so that the above-tensed color-separating electrode may be welded to the upper surface of the pair of opposite sides of the above-compressed frame.

In this method, welding is performed by carrying current intermittently from one side roller electrode to another side roller electrode, while contacting the tensed color-separating electrode onto the upper surface of the pair of opposite sides of the compressed frame, and, in this state, moving the roller electrode that contacts onto the surface of the color-separating electrode along the contacting portion of the upper surface of the frame side and the rear surface of the color-separating electrode.

It is also known that, in order to control moving position of the roller electrodes easily, the outer edge portion of the upper surface of the frame side is compressed by the electrode surface of the roller electrode via the color-separating electrode by tilting the rotation shaft of the roller electrode so that the electrode surface of the roller electrode faces to inside of the frame, whereby the roller electrode may be moved along welding paths in case where the outer edge portion of the upper surface is set as aimed welding paths. It is also known to use a roller electrode having a conic trapezoidal shape instead of the roller electrode in which the rotation shaft is tilted. For example, refer to Japanese Patent Application Laid-Open No. 2000-67748 (pages 3 to 6, FIG. 5).

However, the conventional method of manufacturing a color-separating electrode structure of a color CRT by use of such roller electrodes involves a problem that each of the electrode surfaces of the roller electrodes may contact some part of the front surface of the color-separating electrode other than a specific part to be contacted and welded while each of the roller electrodes moves along the outer edge portion of the upper surface of the side of the frame. When the rotation shaft of the roller electrode is tilted, or when the roller electrode having a conic trapezoidal shape is used as disclosed in the above-mentioned patent document, it is possible to avoid the electrode surfaces of the roller electrodes from contacting any part of the front surface of the color-separating electrode lying inside the outer edge portions of the upper surfaces of the sides of the frame. However, it is not possible to avoid them from contacting any part of the front surface of the color-separating electrode lying outside the outer edge portions. If the electrode surface of the roller electrode contacts any part of the front surface of the color-separating electrode other than the specific part to be contacted and welded, some of the welding current from the roller electrode is diverted, causing welding strength to be insufficient.

### SUMMARY OF THE INVENTION

The present invention has been made in view of the above-described problem with an object to enable welding the color-separating electrode to the frame by use of the roller electrodes without causing diversion of the welding current so that the color-separating electrode structures having sufficient welding strength can be manufactured with high stability.

The object can be achieved by a method of manufacturing a color-separating electrode structure for color cathode ray tube, including the steps of:

applying a compression force to a substantially rectangular frame in a direction that decreases a distance between at least one pair of opposite sides of the frame;

placing, onto the frame compressed, a color-separating electrode made of a thin metal plate having a plurality of electron beam passing holes formed therein while applying a tension force in a direction opposite to the direction to the color-separating electrode; and

welding the color-separating electrode to the side of the frame by rolling a roller electrode that comes into contact with a front surface of the color-separating electrode.

The welding is performed by rolling the roller electrode with a rotation shaft being tilted so that an electrode surface of the roller electrode faces to an inside of the side of the frame, and by pressing a pressing roller to a portion defined as the portion of an outside of a contact portion in which an outer edge portion of the upper surface of the side of the frame is kept in contact with a rear surface of the color-separating electrode, both the roller electrode and the pressing roller being rolled together along the contact portion.

The object can be achieved also by a method of manufacturing a color-separating electrode structure for color cathode ray tube, including the steps of:

applying a compression force to a substantially rectangular frame in a direction that decreases a distance between at least one pair of opposite sides of the frame;

placing, onto the frame compressed, a color-separating electrode made of a thin metal plate having a plurality of electron beam passing holes formed therein while applying a tension force in a direction opposite to the direction to the color-separating electrode;

deforming the color-separating electrode by pressing a pressing roller to a portion defined as the portion of an outside of contact portion which an outer edge portion of an upper surface of the side of the frame is kept in contact with a rear surface of the color-separating electrode while rolling the pressing roller along the contact portion; and

welding, after the deforming, a rear surface of the color-separating electrode to the outer edge portion of the upper surface of the side of the frame by rolling a roller electrode with a rotation shaft being tilted so that an electrode surface of the roller electrode faces to an inside of the side of the frame.

### BRIEF DESCRIPTION OF THE DRAWINGS

FIG. 1 is an explanatory view for explaining a welding process of a method of manufacturing a color-separating electrode structure for use in a color CRT of a first preferred embodiment according to the present invention;

FIG. 2 shows a frame and a color-separating electrode viewed from the direction of a short side during the welding process of the manufacturing method of the first preferred embodiment;

FIG. 3 shows the frame and the color-separating electrode viewed from the direction of a long side during the welding process of the manufacturing method of the first preferred embodiment;

FIG. 4 is an enlarged view of part of the color-separating electrode and part of the frame in the vicinity of a roller electrode during the welding process of the manufacturing method of the first preferred embodiment;

FIG. 5 shows a frame and a color-separating electrode viewed from the direction of the short side during a welding process of a method of manufacturing a color-separating electrode structure for use in a color CRT of a second preferred embodiment according to the present invention;

FIG. 6 shows the frame and the color-separating electrode viewed from the direction of the long side during the welding process of the manufacturing method of the second preferred embodiment;

FIG. 7 is an enlarged view of part of the color-separating electrode and part of the frame in the vicinity of the roller electrode during the welding process of the manufacturing method of the second preferred embodiment;

FIG. 8 shows a frame and a color-separating electrode viewed from the direction of the short side during a color-separating electrode pressing process of a method of manufacturing a color-separating electrode structure for use in a color CRT of a third preferred embodiment according to the present invention;

FIG. 9 shows the frame and the color-separating electrode viewed from the direction of the long side during the color-separating electrode pressing process of the manufacturing method of the third preferred embodiment; and

FIG. 10 is an enlarged view of part of the color-separating electrode and part of the frame in the vicinity of the roller electrode during the welding process of the manufacturing method of the third preferred embodiment.

### DESCRIPTION OF THE PREFERRED EMBODIMENTS

A First Preferred Embodiment

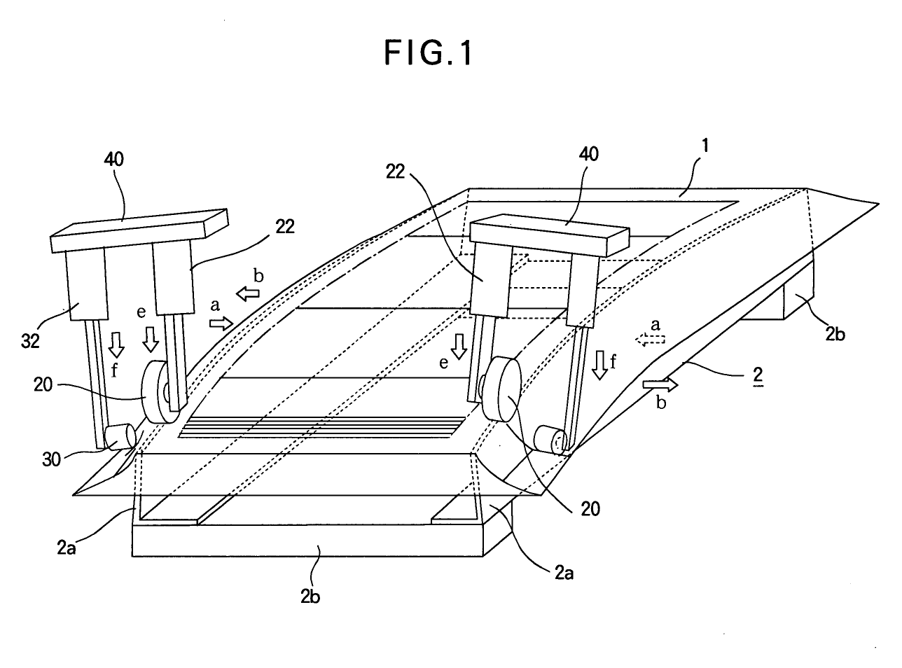

A welding process of a method of manufacturing a color-separating electrode structure of a first preferred embodiment according to the present invention will be explained with reference to FIGS. 1 to 4. In FIG. 1, a color-separating electrode 1, which may be a shadow mask made of a thin metal plate having a number of rectangular holes formed therein or an aperture grille made of a thin metal plate having a number of slits formed therein, is applied with a tension force in the direction shown by the arrow “b” (referred to as “the b-direction” hereinafter). A rectangular frame 2 is formed by fixing a pair of long sides 2a opposed to each other in the vertical direction to a pair of short sides 2b opposed to each other in the horizontal direction. The long sides 2a are applied with a compression force in a direction that decreases the distance between the pair of the long sides 2a, that is, in the direction shown by the arrow “a” (referred to as “the a-direction” hereinafter). The color-separating electrode 1 is placed on the upper surfaces of the long sides 2a, while keeping in contact with each other.

Roller electrodes 20 of welding devices 22 mounted on traveling devices 40 move on the front surface of the color-separating electrode 1. In this embodiment, a color-separating electrode pressing device 32 having a pressing roller 30 is also mounted on the traveling device 40. This pressing roller 30 travels on the front surface of the color-separating electrode 1 together with the roller electrode 20. The welding device 22 is applied with force in the direction shown by the arrow “e” (referred to as “the e-direction” hereinafter), and the color-separating electrode 1 is therefore pressed against the upper surface of the long side 2a by the electrode surface of the roller electrode 20. Likewise, the color-separating electrode pressing device 32 is applied with force in the direction shown by the arrow “f” (referred to as “the f-direction” hereinafter). Accordingly, an outer portion of the color-separating electrode 1 lying outside the frame 2 is pressed so as to come close to a lateral surface of the long side 2a.

As described above, in this preferred embodiment, the welding device 22 and the color-separating electrode pressing device 32 are mounted to the same traveling device 40 so that the welding device 22 and the color-separating electrode pressing device 32 may be moved simultaneously, whereby the color-separating electrode 1 can be welded to the long sides 2a of the frame while the color-separating electrode 1 is being compressed and deformed.

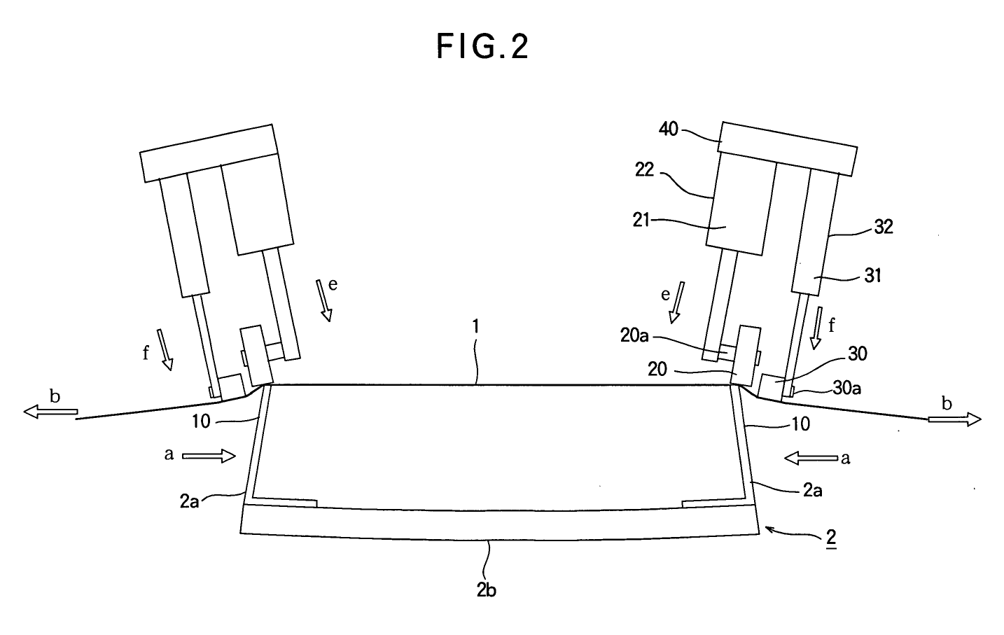

FIG. 2 shows the frame 2 viewed from the direction of the short side 2b during the welding step. Since the long sides 2a are applied with the compression force, the upright portions 10 thereof are inclined inward, causing the short sides 2b to warp concavely. The roller electrode 20 at the end of the welding device 22 is pressed in the e-direction by a roller electrode pressing means 21. A rotation shaft 20a of the roller electrode 20 is inclined so that the electrode surface of the roller electrode 20 faces to the inside of the frame 2. Likewise, the pressing electrode 30 at the end of the welding device 22 is pressed in the f-direction by a pressing roller pressing means 31. Although a rotation shaft 30a of the pressing roller 30 is inclined as with the rotation shaft 20a of the roller electrode 20, the shaft 30a does not necessarily require being inclined.

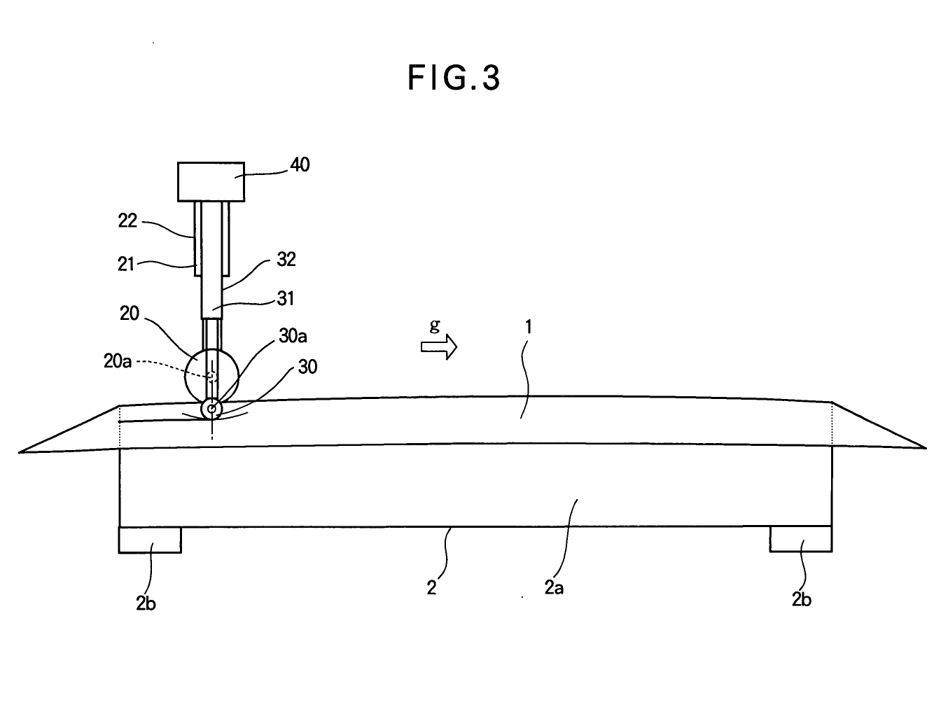

FIG. 3 shows the frame 2 viewed from the direction of the long side 2a during the welding step. The welding device 22 and the color-separating electrode pressing device 32 move in the direction shown by the arrow “g” (referred to as “the g-direction” hereinafter) by the traveling device 40. The rotation shaft 20a of the roller electrode 20 of the welding device 22 and the rotation shaft 30a of the pressing roller 30 of the color-separating electrode pressing device 32 are in the same position with respect to the traveling direction (the g-direction).

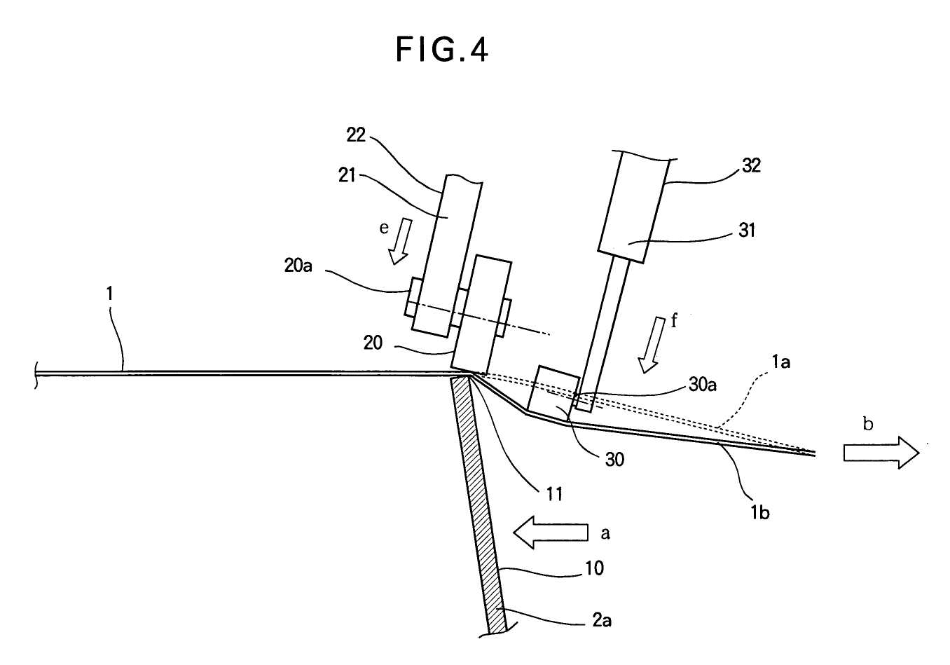

FIG. 4 is an enlarged view of part of the color-separating electrode 1 and part of the frame 2 in the vicinity of the roller electrode 20. Since the upright portion 10 of the long side 2a is inclined inward, the rear surface of the color-separating electrode 1 is not brought into contact with the upper surface of the upright portion 10, but only the outer edge portion 11 of the upper surface is in contact with the rear surface of the color-separating electrode 1.

Furthermore, since the roller electrode pressing means 21 applies a force to the roller electrode 20 in thee-direction, the electrode surface of the roller electrode 20 and the outer edge portion 11 are in contact against each other via the color-separating electrode 1. In this case, as the rotation shaft 20a of the roller electrode 20 is tilted so that the electrode surface of the roller electrode 20 faces to inside of the frame, the electrode surface of the roller electrode 20 is not brought into contact with portion—defined as portion of the inside of the outer edge portion 11—of the front surface of the color-separating electrode.

Portion—defined as portion of the outside of the outer edge portion 11—of the front surface of the color-separating electrode 1, is brought into contact with an end portion of the electrode surface of the roller electrode 20, for the above-defined portion is positioned in the dotted lines 1a as shown in the FIG. 4 before the above-defined portion is pressed by the pressing roller 32. Whereas, when the above-defined portion is pressed by the pressing roller 32 in the f-direction, the above-defined portion deforms in the direction facing to the long sides 2a of the frame as shown in the solid lines 1b, whereby the above-defined portion is not brought into contact with the end portion of the electrode surface of the roller electrode 20.

According to this embodiment, since the electrode surface of the roller electrode 20 is not brought into contact with color-separating electrode 1 at the portion other than outer edge portion 11 of the upper surface of the upright portion 10 of the long side 2a of the frame by properly setting the pressing force of the color-separating electrode pressing device 32 and the position of the pressing roller 30 at the end thereof diversion of the welding current can be restrained, whereby the color-separating electrode structure having sufficient welding strength can be obtained with higher stability.

A Second Preferred Embodiment

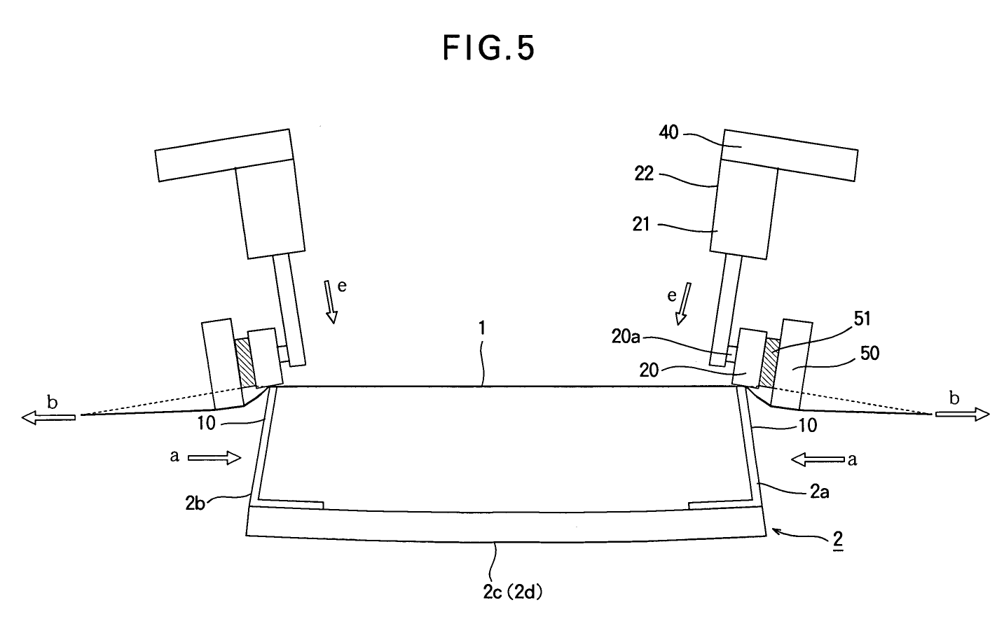

A welding step of a method of manufacturing a color-separating electrode structure of a second preferred embodiment according to the present invention will be explained with reference to FIGS. 5 to 7. The structural elements shown in FIGS. 5 to 7 that are identical or equivalent to those shown in FIGS. 1 to 4 are given the same reference characters, and explanation thereof will be omitted. FIG. 5 shows the frame 2 viewed from the direction of the short side 2b during the welding step. Since the long sides 2a are applied with the compression force, the upright portions 10 thereof are inclined inward, causing the short sides 2b to warp concavely. The welding device 22 mounted on the traveling device 40 comprises the roller electrode 20 and the roller electrode pressing means 21 pressing the roller electrode 20 in the e-direction. The rotation shaft 20a of the roller electrode 20 is inclined so that the electrode surface of the roller electrode 20 faces to the inside of the frame 2.

In the second preferred embodiment, a color-separating electrode pressing roller 50 having a diameter larger than that of the roller electrode 20 is mounted to the rotation shaft 20a of the roller electrode 20 in such a way that it is positioned outside the roller electrode 20 with an insulating member 51 retained between the roller electrode 20 and the pressing roller 50. Accordingly, the color-separating electrode pressing roller 50 is positioned outside the insulating member 51 retained between the roller electrode 20 and the color-separating electrode pressing roller 50.

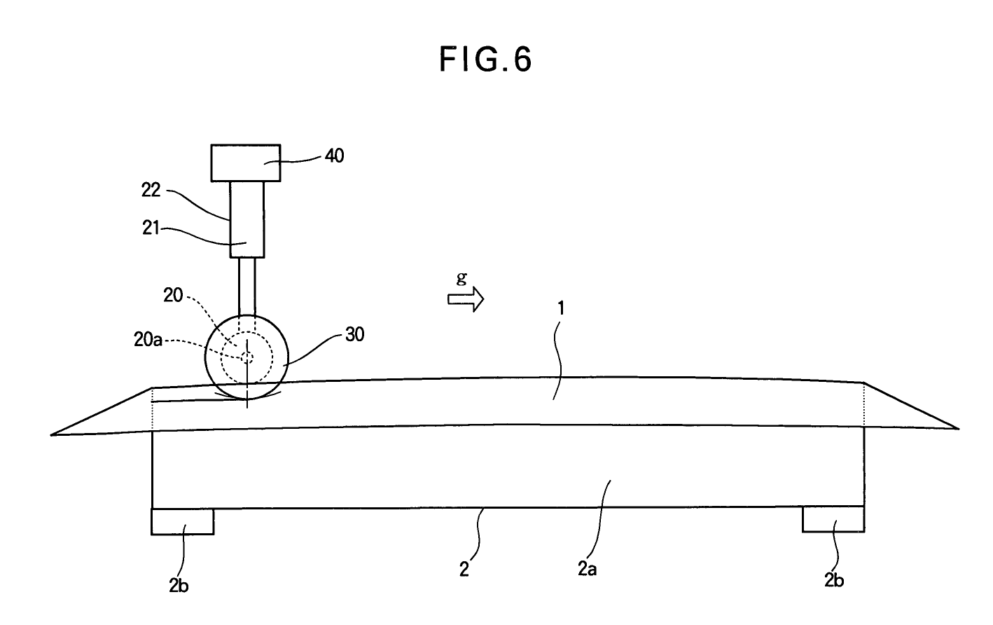

FIG. 6 shows the frame 2 viewed from the direction of the long side 2a during the welding step. As with the first preferred embodiment, the welding device 22 moves in the g-direction by the traveling device 40. However, this second preferred embodiment enables pressing the color-separating electrode 1 to deform and welding the color-separating electrode 1 to the long sides 2a at a time without using the color-separating electrode pressing device, since the roller electrode 20 of the welding device 22 and the color-separating electrode pressing roller 50 are mounted to the common rotation shaft 20a.

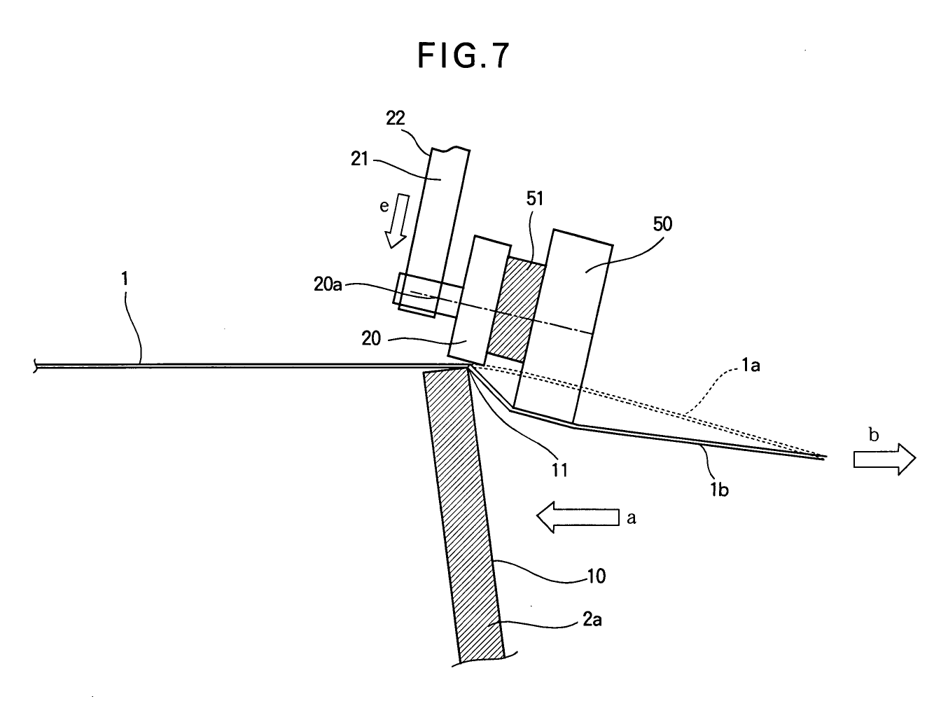

FIG. 7 is an enlarged view of part of the color-separating electrode 1 and part of the frame 2 in the vicinity of the roller electrode 20. As with the first preferred embodiment, the rear surface of the color-separating electrode 1 is not brought into contact with the upper surface of the upright portion 10 since the upright portion 10 of the long side 2a is inclined inward, but only the outer edge portion 11 of the upper surface is in contact with the rear surface of the color-separating electrode 1. Furthermore, since the roller electrode pressing means 21 applies a force to the roller electrode 20 in the e-direction, the electrode surface of the roller electrode 20 and the outer edge portion 11 are in contact against each other via the color-separating electrode 1. In this case, as the rotation shaft 20a of the roller electrode is tilted so that the electrode surface of the roller electrode 20 faces to inside of the frame, the electrode surface of the roller electrode 20 is not brought into contact with portion—defined as the portion of the inside of the outer edge portion 11—of the front surface of the color-separating electrode.

Portion—defined as the portion of the outside of the outer edge portion 11—of the front surface of the color-separating electrode 1, is brought into contact with an end portion of the electrode surface of the roller electrode 20, for the above-defined portion is positioned in the dotted lines 1a as shown in the FIG. 7 before the above-defined portion is pressed by the pressing roller 50. Whereas, when the above-defined portion is pressed by the pressing roller 50, the above-defined portion deforms in the direction facing to the long sides 2a of the frame as shown in the solid lines 1b, whereby the above-defined portion is not brought into contact with the end portion of the electrode surface of the roller electrode 20.

According to the second preferred embodiment, since the electrode surface of the roller electrode 20 is not brought into contact with the color-separating electrode 1 at the portion other than the outer edge portion 11 of the upper surface of the upright portion 10 of the long side 2a of the frame by properly setting the pressing force of the color-separating electrode pressing device 21 and the outer diameter of the color-separating electrode pressing roller 50, diversion of the welding current can be restrained, whereby the color-separating electrode structure having sufficient welding strength can be obtained with higher stability.

A Third Preferred Embodiment

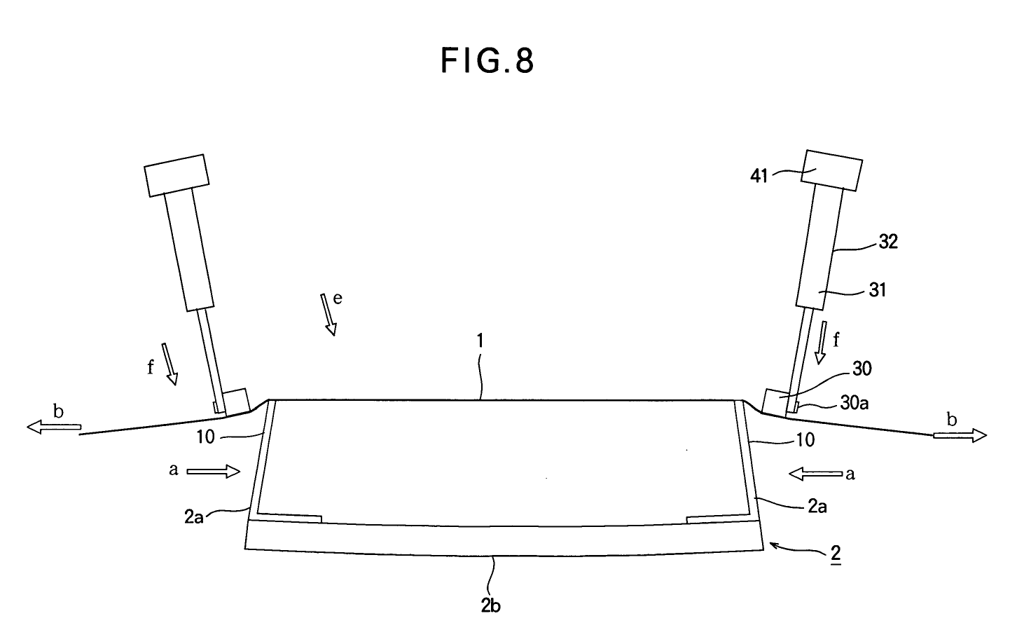

A color-separating electrode pressing step and a welding step of a method of manufacturing a color-separating electrode structure of a third preferred embodiment according to the present invention will be explained with reference to FIGS. 8 to 10. The structural elements shown in FIGS. 8 to 10 that are identical or equivalent to those shown in FIGS. 1 to 4 are given the same reference characters, and explanation thereof will be omitted. FIG. 8 shows the frame 2 viewed from the direction of the short side 2b during the color-separating electrode pressing step that is performed before the welding step. Since the long sides 2a are applied with the compression force, the upright portions 10 thereof are inclined inward, causing the short sides 2b to warp concavely. In this embodiment, the color-separating electrode pressing device 32 is mounted on a traveling device 41 to press the pressing roller 30 in the f-direction by the pressing roller pressing means 31 against a portion—defined as the portion of the outside of the long side 2a—of the front surface of the color-separating electrode 1, thereby pressing down the above-mentioned portion. Although the rotation shaft 30a of the pressing roller 30 is inclined in order that the electrode surface of the pressing roller 30 faces to the inside of the frame 2, the rotation shaft 30a does not necessarily require being inclined.

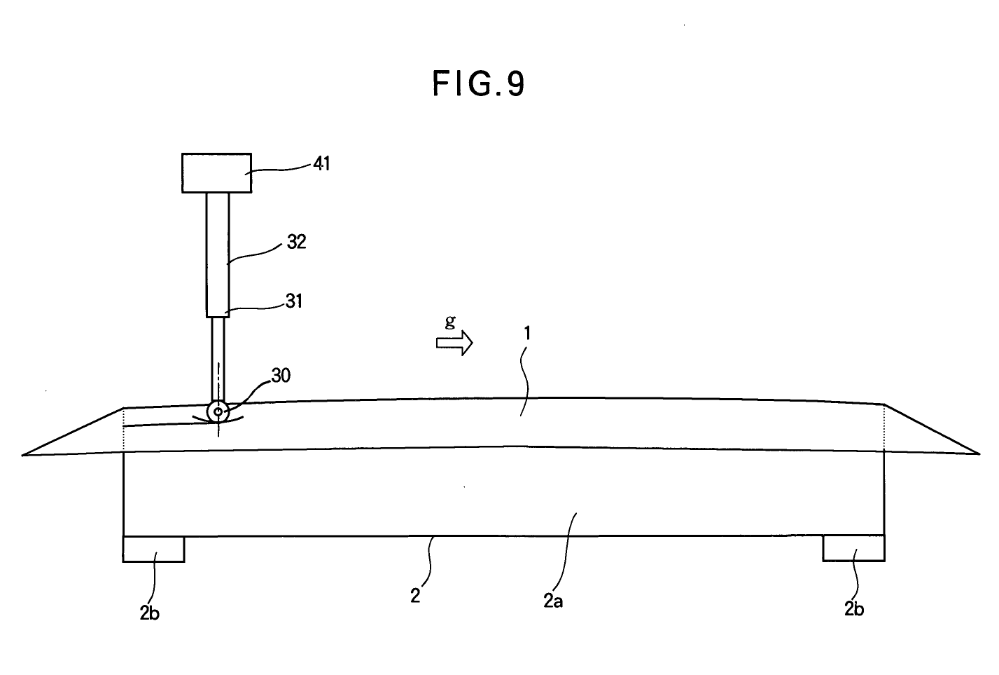

FIG. 9 shows the frame 2 viewed from the direction of the long side 2a during the color-separating electrode pressing step. In the above-described color-separating electrode pressing step, the color-separating electrode pressing device 32 moves by the traveling device 41 in order that the portion—defined as the portion of the outside of the long side 2a-of the front surface of the color-separating electrode is deformed in advance of the welding step.

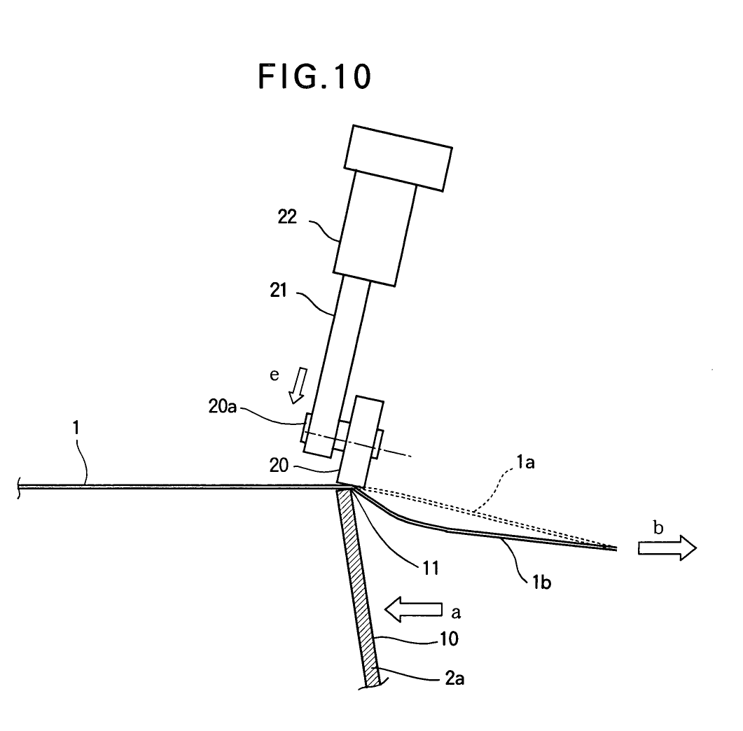

FIG. 10 is an enlarged view of part of the color-separating electrode 1 and part of the frame 2 in the vicinity of the roller electrode 20. As with the first preferred embodiment, the rear surface of the color-separating electrode 1 is not brought into contact with the upper surface of the upright portion 10 of the long side 2a, since the upright portion 10 of the long side 2a is inclined inward, but only the outer edge portion 11 of the upper surface is in contact with the rear surface of the color-separating electrode 1. Furthermore, since the roller electrode pressing means 21 applies a force to the roller electrode 20 in the e-direction, the electrode surface of the roller electrode 20 and the outer edge portion 11 are in contact against each other via the color-separating electrode 1. In this case, as the rotation shaft 20a of the roller electrode 20 is tilted so that the electrode surface of the roller electrode 20 faces to inside of the frame, the electrode surface of the roller electrode 20 is not brought into contact with portion—defined as the portion of the inside of the outer edge portion 11—of the front surface of the color-separating electrode.

In this preferred embodiment, the portion—defined as the portion of the outside of the outer edge portion 11—of the color-separating electrode 1 is deformed as shown in the position from the dotted lines 1a to the solid lines 1b during the pressing step of the color-separating electrode, so that the end portion of the electrode surface of the roller electrode 20 is not brought into contact with the defined portion of the color-separating electrode during the welding step.

According to the third preferred embodiment, during the welding step, since the electrode surface of the roller electrode 20 is not brought into contact with the color-separating electrode 1 at the portion other than the outer edge portion 11 of the upper surface of the upright portion 10 of the long side 2a of the frame, diversion of the welding current can be restrained, whereby the color-separating electrode structure having sufficient welding strength can be obtained with higher stability.

The above explained preferred embodiments are exemplary of the invention of the present application which is described solely by the claims appended below. It should be understood that modifications of the preferred embodiments may be made as would occur to one of skill in the art.

What is claimed is:

1. A method of manufacturing a color-separating electrode structure for color cathode ray tube, comprising the steps of:
applying a compression force to a substantially rectangular frame in a direction that decreases a distance between at least one pair of opposite sides of the frame;
placing, onto the frame compressed, a color-separating electrode made of a thin metal plate having a plurality of electron beam passing holes formed therein while applying a tension force in a direction opposite to the direction to the color-separating electrode; and
welding the color-separating electrode to the side of the frame by rolling a roller electrode that comes into contact with a front surface of the color-separating electrode,
wherein the welding is performed by rolling the roller electrode with a rotation shaft being tilted so that an electrode surface of the roller electrode faces to an inside of the side of the frame, and by pressing a pressing roller to a portion defined as the portion of an outside of a contact portion in which an outer edge portion of the upper surface of the side of the frame is kept in contact with a rear surface of the color-separating electrode, both the roller electrode and the pressing roller being rolled together along the contact portion.

2. A method of manufacturing a color-separating electrode structure for a color cathode ray tube according to claim 1, in which the roller electrode and the pressing roller are mounted on a common traveling device.

3. A method of manufacturing a color-separating electrode structure for use in a color cathode ray tube according to claim 1, in which the pressing roller has a diameter larger than that of the roller electrode and is mounted to a rotation shaft of the roller electrode in such a way that the pressing roller is positioned outside an insulating member retained between the roller electrode and the pressing roller.

4. A method of manufacturing a color-separating electrode structure for color cathode ray tube, comprising the steps of:
applying a compression force to a substantially rectangular frame in a direction that decreases a distance between at least one pair of opposite sides of the frame;
placing, onto the frame compressed, a color-separating electrode made of a thin metal plate having a plurality of electron beam passing holes formed therein while applying a tension force in a direction opposite to the direction to the color-separating electrode;
deforming the color-separating electrode by pressing a pressing roller to a portion defined as the portion of an outside of contact portion which an outer edge portion of an upper surface of the side of the frame is kept in contact with a rear surface of the color-separating electrode while rolling the pressing roller along the contact portion; and
welding, after the deforming, a rear surface of the color-separating electrode to the outer edge portion of the upper surface of the side of the frame by rolling a roller electrode with a rotation shaft being tilted so that an electrode surface of the roller electrode faces to an inside of the side of the frame.

5. A method of manufacturing a color-separating electrode structure for a color cathode ray tube according to claim 4, in which the roller electrode and the pressing roller are mounted on a common traveling device.

6. A method of manufacturing a color-separating electrode structure for use in a color cathode ray tube according to claim 4, in which the pressing roller has a diameter larger than that of the roller electrode and is mounted to a rotation shaft of the roller electrode in such a way that the pressing roller is positioned outside an insulating member retained between the roller electrode and the pressing roller.
